(19) United States
(12) Patent Application Publication
(10) Pub. No.: US 2009/0084161 A1
(43) Pub. Date: Apr. 2, 2009

(54) HYDROGEN SENSOR

(75) Inventors: Marion Wienecke, Wismar (DE); Petra Fedtke, Rugkamp (DE); Torsten Barfels, Wismar (DE); Andreas Busch, Wismar (DE); Carmen Bunesch, Wismar (DE); Gero Bramann, Wismar (DE)

Correspondence Address: MICHAUD-DUFFY GROUP LLP, 306 INDUSTRIAL PARK ROAD, SUITE 206, MIDDLETOWN, CT, 06457, US

(73) Assignee: HOCHSCHULE WISMAR, Wismar (DE)

(21) Appl. No.: 12/254,040

(22) Filed: Oct. 20, 2008

Related U.S. Application Data
(63) Continuation of application No. PCT/EP2007/003472, filed on Apr. 20, 2007.

(30) Foreign Application Priority Data
Apr. 20, 2006 (DE) 10 2006 018 767.9

(51) Int. Cl. G01N 7/00

(52) U.S. Cl. 73/31.05

(57) ABSTRACT

The invention relates to a hydrogen sensor with a radiation source, by means of which electromagnetic radiation is radiated onto a sensor medium, wherein the sensor medium has a transmission coefficient that varies as a function of the concentration of hydrogen in the environment of the sensor medium, and with a detector that detects at least a portion of the radiation transported through the sensor medium. The hydrogen sensor according to the invention is characterized by the fact that a reflector is provided that reflects the radiation transmitted through the sensor medium back to the sensor medium. The hydrogen sensor according to the invention is further characterized by the fact that the sensor medium incorporates clusters containing or consisting of a palladium alloy, yttrium, scandium, at least one lanthanide, at least one actinoide, tungsten oxide and/or vanadium oxide, and/or a mixture or compound of these materials.

### CROSS-REFERENCE TO RELATED APPLICATIONS

This application is a continuation of and claims priority to International Patent Application No. PCT/EP2007/003472 filed on Apr. 20, 2007, which claims priority to German Patent Application No. 10 2006 018 767.9 filed on Apr. 20, 2006, the subject matter of these patent documents is incorporated by reference herein in its entirety.

### FIELD OF THE INVENTION

The invention relates to a hydrogen sensor, and in particular, to a hydrogen sensor which contains a sensor medium whose transmission coefficient for the transmission of radiation varies depending on the concentration of hydrogen in the environment of the sensor medium.

### BACKGROUND

The physical principle of a hydrogen sensor is known from Petra Fedtke, Marion Wienecke, Mihaela-C. Bunescu, Marlis Pietrzak, K. Deistung, Erika Borchardt in “Hydrogen sensor based on optical and electrical switching”, Sensors and Actuators B 100 (2004) 151-157. In this case, a thin palladium layer or a layer of a palladium cluster layer serves for exploiting the physical effect that the optical transmission of the palladium layer changes when hydrogen is present in the environment of the palladium layer. This takes place as a result of incorporation or chemical reaction of hydrogen with the palladium, whereby the electronic structure of the palladium changes, in particular around the Fermi level.

### SUMMARY OF THE INVENTION

The present invention resides in one aspect in a hydrogen sensor with a radiation source, by means of which radiation is radiated onto a sensor medium. The sensor medium has a transmission coefficient that varies depending on the concentration of hydrogen in the environment of the sensor medium. The sensor includes a detector which detects at least a portion of the radiation transported through the sensor medium. A reflector is provided to reflect the radiation transmitted through the sensor medium back to the sensor medium.

The present invention resides in another aspect in a hydrogen sensor with a radiation source, by means of which radiation is radiated onto a sensor medium. The sensor medium has a transmission coefficient that varies depending on the concentration of hydrogen in the environment of the sensor medium. The sensor includes a detector which detects at least a portion of the radiation transported through the sensor medium. The sensor medium comprises clusters containing or composed of a palladium alloy, yttrium, scandium, at least one lanthanide, at least one actinoide, tungsten oxide and/or vanadium oxide and/or a mixture or compound of these materials.

### BRIEF DESCRIPTION OF THE DRAWINGS

FIG. 1 is a schematic sectional illustration through a sensor according to one embodiment of the invention.

FIG. 2 is a schematic sectional illustration through a substrate with correspondingly applied layers.

FIG. 3 is a transmission electron micrograph of a sensor layer.

### DETAILED DESCRIPTION

The invention relates to a hydrogen sensor with a radiation source, by means of which electromagnetic rays (also referred to herein as “radiation” and “rays”) are radiated onto a sensor medium, wherein the sensor medium has a transmission coefficient that varies depending on the concentration of hydrogen in the environment of the sensor medium, and with a detector, which detects at least a portion of the radiation transported through the sensor medium.

The hydrogen sensor according to one aspect of the invention utilizes the basic concept of utilizing the sensor medium at least twice in order thus, in conjunction with little material outlay, which leads to stable sensor media, to enable a high sensitivity of the sensor and a long lifetime. This is because in accordance with the prior art the situation is such that correspondingly thick layers, usually composed of palladium or palladium clusters, are used which, starting from a correspondingly high loading with hydrogen, for example above 10% in the case of the palladium clusters and above 4% in the case of crystalline layers, detach from the substrate after a few loading cycles with hydrogen such that the sensor no longer provides reproducible results. The solution according to the invention of permitting the electromagnetic rays to pass through the sensor medium at least twice, makes it possible to use a very thin sensor medium, which then does not lead to a corresponding degradation of the sensor medium on account of relatively frequent loading with hydrogen or on account of a high concentration of hydrogen in the environment of the sensor medium.

Preferably, the sensor medium is applied on a substrate, which improves the handleability of the sensor medium. Preferably, the substrate is the reflector or a reflector is applied on the substrate. For this purpose, in particular preferably the sensor medium is applied on the top side of the substrate and a reflective surface is applied on the underside or rear side. The substrate can be for example glass or a mirror.

If a buffer layer is provided between the substrate and the sensor medium, differences with respect to the lattice constant between substrate and sensor medium can be compensated for. By way of example, calcium fluoride (CaF₂) is suitable as buffer layer. The substrate is preferably transparent or substantially transparent to the electromagnetic rays and preferably not reactive to hydrogen.

If a covering layer is provided on the sensor medium, which covering layer is in particular preferably transparent, not reactive with hydrogen or substantially not reactive with hydrogen and/or hydrogen-permeable, the sensor medium is also arranged in protected fashion in the sensor. The covering layer can also be embodied as partly reflective, such that it is possible to produce not only double passage of the electromagnetic rays through the sensor medium, but also multiple passage. The sensor medium is preferably embodied as a layer.

A particularly durable sensor medium which can take up a high proportion of hydrogen without incurring damage is provided by a sensor medium that comprises clusters of palladium, palladium alloys, yttrium, scandium, at least one lanthanide, at least one actinoide, tungsten oxide and/or vanadium oxide and/or a mixture or compound of these materials. Palladium alloys used are, in particular, palladium alloys comprising iron, nickel and tungsten. Lanthanides are elements 57 to 71 of the periodic table. The actinoides are elements 89 to 103 of the periodic table.

In the context of the invention, clusters are, in particular, accumulations of atoms of the aforementioned materials that are chemically or physically bonded to one another. Clusters can also be crystals or crystallites. In one embodiment, the sensor medium is a composite comprising clusters and a further material, into which the clusters are embedded. The clusters may be embedded in a matrix composed of a different material, in particular a polymer. It is thereby possible to compensate for the changes in the lattice constant of the material of which the clusters are composed or which the clusters contain, in the presence of different hydrogen concentrations, such that the sensor medium is then not degraded or irreversibly destroyed given an excessively high proportion of hydrogen in the sensor medium or upon repeated loading with hydrogen.

Preferably, the clusters have a diameter of about 1 nm to about 30 nm, optionally about 2 nm to about 15 nm, for example, about 3 nm to about 10 nm.

The clusters are preferably nanocrystallites or nanocrystals. Preferably, the polymer comprises or consists of polytetrafluoroethylene, polyterephthalate, polyimide, polymethyl methacrylate and/or polycarbonate.

A hydrogen sensor with very good handleability is afforded when electromagnetic rays are conducted by at least one first optical waveguide from a radiation source to the sensor medium. Preferably, the rays reflected from the reflector and transmitted through the sensor medium are conducted by at least one second optical waveguide to the detector. Preferably, the at least one first and the at least one second optical waveguide run substantially parallel at least in sections, or are arranged in such a way. Preferably, the optical waveguides run parallel to one another substantially completely over their entire length.

Preferably, a lens that focuses the rays is provided at that end of the at least one first and/or second optical waveguide which is directed to the sensor medium. The focus of the lens is preferably set to the mirror surface or the sensor medium.

A hydrogen sensor according to another aspect of this invention has a radiation source, by means of which electromagnetic rays are radiated onto a sensor medium, wherein the sensor medium has a transmission coefficient that varies depending on the concentration of hydrogen in the environment of the sensor medium, and with a detector, which detects at least a portion of the radiation transported through the sensor medium, wherein the sensor medium comprises clusters containing or composed of a palladium alloy, yttrium, scandium, at least one lanthanide, at least one actinoide, tungsten oxide and/or vanadium oxide and/or a mixture or compound of these materials. The tungsten oxide is preferably present with a chemical formula WO₃. Vanadium oxide is preferably present with a chemical formula V₂O₅. The materials preferably form metal hydrides with hydrogen, such as metal H₃ for example.

A hydrogen sensor having a long lifetime and a high long-term stability is made possible by using clusters containing or comprising the abovementioned materials.

Preferably, the clusters are embedded in a matrix composed of a different material, in particular a polymer. Preferably, the clusters have a diameter of about 1 nm to about 30 nm, optionally about 2 nm to about 15 nm, for example, about 3 nm to about 10 nm or, optionally about 3 to about 5 nm. The polymer comprises or consists preferably of polytetrafluoroethylene, polyterephthalate, polyimide, polymethyl methacrylate and/or polycarbonate.

Preferably, the sensor medium is applied on a substrate. A buffer layer is furthermore preferably provided between substrate and sensor medium. If a covering layer is provided on the sensor medium, said covering layer can serve for protecting the sensor medium and/or also be embodied in reflective fashion in order to enable the electromagnetic rays to be transmitted multiply through the sensor medium. In the context of the invention, in particular platinum, gold or some other inert material can serve as the covering layer. In this case, the thickness of the covering layer should be so thin that hydrogen can diffuse through without any problems and the electromagnetic rays, which are preferably in the range of visible or ultraviolet light, can also pass through at least in sections. Preferably, at the location at which the electromagnetic rays impinge on the sensor medium for the first time, no covering layer is provided or a covering layer that is transparent to said rays is provided. Said rays are then preferably transmitted through the sensor medium, passed to a mirror or reflector, are reflected and conducted through the sensor medium again to a covering layer that is reflective to the electromagnetic rays, and are then once again conducted through the sensor medium, reflected again and transported again through the sensor medium so as then to emerge from the sensor medium and be conducted to a detector. The sensor medium, in relation to the thickness of the sensor medium, can thereby be four times as sensitive as conventional sensor media or sensors with the same thickness. The sensor medium is preferably embodied as a layer.

An exemplary embodiment of the invention is described below with reference to the drawings, without intending to impose any limitation of the general concept of the invention as more broadly described herein.

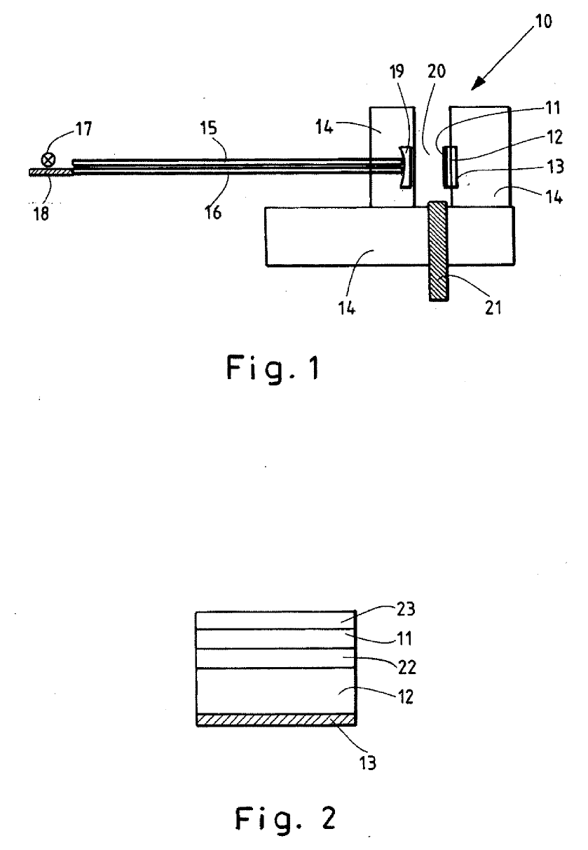

FIG. 1 shows a schematic sectional illustration through a sensor 10 according to the invention. The measurement principle of the sensor is based on the measurement of the change in intensity of a light signal. The signal or rays are generated by means of a light-emitting diode or light source 17, preferably with a wavelength of 350 to 450 nm. The light, which is preferably in the ultraviolet, is coupled directly into an ultraviolet optical waveguide 15, having a diameter of about 400 μm, although the invention is not limited in this regard, and in other embodiments the waveguide may have any other suitable diameter. The optical waveguide 15 transports the rays or the light signal to the measuring location. Preferably, the rays are conducted perpendicular to the functional layer or sensor layer 11. A collimator lens 19 can be used for this purpose. When a collimator lens is used, the subsequent measurement signal is higher for the same light power. However, the arrangement also functions without a collimator lens 19 since the coupling of the reflected light into the optical waveguide 15 leading to the detector 18 is based on the scattering of light at the nanostructure sensor layer 11.

If a collimator lens 19 is used, it is not necessary to align it in order to couple the reflected beam into the optical waveguide 15. Between the collimator lens 19 or, in the variant without a collimator lens, between the optical waveguide 15 or 16 and the sensor layer 11, the medium to be measured is arranged in the environment 20. The distance between the collimator lens 19 or the optical waveguide 15, 16 and the sensor layer 11 is a few millimeters. The rays penetrate or pass through the sensor layer 11 and are correspondingly influenced in terms of intensity or power depending on the hydrogen content. The more hydrogen is provided in the environment 20, the more hydrogen can be incorporated into the sensor layer 11 and change the active substance, in particular chemochromatic substance, there in such a way that the transmission coefficient is reduced. In other words, the light transmitted through the sensor layer is attenuated depending on the concentration of hydrogen.

The sensor layer 11 is preferably applied on a glass substrate or a substrate 12 such as, for example, a sapphire substrate or a strontium titanate substrate or a diamond substrate. The substrate 12 is provided with a reflective rear side 13, that is to say a mirror surface 13, whereby the rays are reflected and once again pass through the sensor layer 11. This leads to a renewed attenuation of the rays which are coupled into the second optical waveguide 16 through a collimator lens 19. A detector in the form of a silicon photodiode, which converts the optical rays or the optical signal into an electrical signal, is provided at that end of the optical waveguide 16 which is remote from the sensor layer. The corresponding components are fixed on a mount 14. Moreover, a gas feed line 21 is provided, which provides for feeding the gas possibly provided with hydrogen. The sensor is shown open in the illustration in FIG. 1. Said sensor is usually provided in a closed housing (not illustrated) with the exception of the gas feed line 21. For better throughflow of the sensor, it is also possible to provide a second opening or a second gas feed line 21.

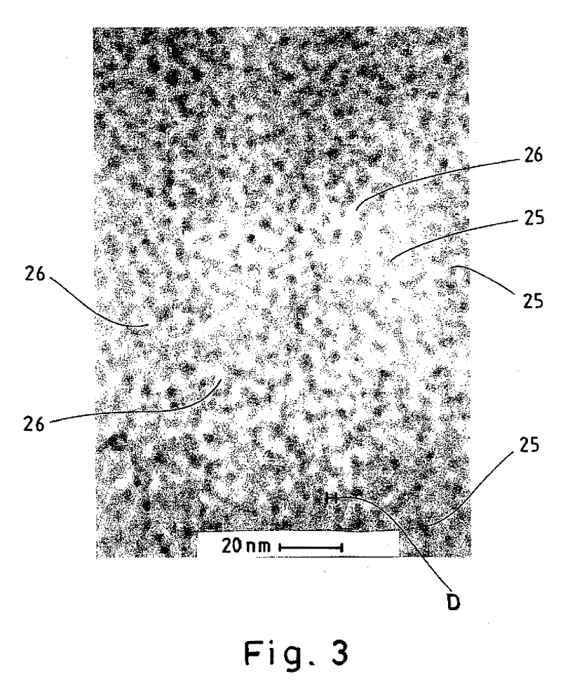

In this particular embodiment, the sensor layer 11 is about 40 nm to about 50 nm thick. However, the invention is not limited in this regard, and in an alternative embodiment the sensor layer may be about 10 nm to about 30 nm thick, or may have any other thickness with which the object of the invention will be served. The area of the sensor layer 11 is preferably at least as large as the beam area of the rays coupled in. The sensor layer is preferably composed of a nanocomposite comprising clusters 25 (cf. FIG. 3) of a size of about 1 nm to about 30 nm, for example, in one particular embodiment, approximately 5 nm. FIG. 3 illustrates a transmission electron micrograph of the sensor layer 11. The dark regions are the metallic regions composed for example of palladium alloy, yttrium, scandium, a lanthanide, an actinoide, tungsten oxide and/or vanadium oxide. The gray or lighter regions are composed of polymer or a mixture of polymers which form a type of matrix, into which the clusters are embedded. A size indication is provided in the lower region of FIG. 3. The black line indicated there against the white background has a length of about 20 nm. D is intended to represent the approximate diameter of a cluster and is approximately 4 nm for the cluster illustrated. In this exemplary embodiment, the polymer is polytetrafluoroethylene. The nanocrystals or clusters 25 are composed of palladium. The size of the clusters can be varied by heat treatment or tempering at temperatures to below 300° C.

FIG. 2 shows a sectional illustration through a substrate with correspondingly applied layers. The substrate 12 has a mirror surface 13 on its underside. On the top side of the substrate 12 there is a buffer layer 22, for example a calcium fluoride layer. Applied thereon is the nanocomposite layer 11 or sensor layer 11 and thereon in turn a covering layer 23, for example composed of platinum.

The layers can be applied on the substrate by sputtering, for example magnetron sputtering, or by means of laser ablation, by means of PECVD, a Sol-Gel method or by means of spin-coating.

As a result of the at least double transmission of the rays through the sensor layer 11, even with thin layers it is possible to generate significant signal changes when corresponding hydrogen concentrations are present. With very thin layers, even high hydrogen concentrations do not lead to a degradation of the sensor layer 11 or to damage to the sensor layer 11. In this exemplary embodiment, the sensor layer 11 is about 50 nm thick. However, it can be produced down to a thickness of about 10 nm with corresponding functionality. Essentially no cross-sensitivities relative to other gases in the danger area can be established. This is due to the fact that the change in the optical transmission of the sensor layer or the composite film is brought about only by alteration of the crystal structure of the clusters 25, in particular nanoclusters, which is to be observed exclusively under the influence of hydrogen.

The sensor has a long lifetime since the actual metal nanoclusters which perform optical switching or bring about the optical effect are embedded in a polymer matrix. Since the matrix is composed of polymers, it can absorb the mechanical stress of the nanoclusters. Neither the nanocomposite nor the overall structure is degenerated. As a result, a long lifetime can be achieved and measurements of hydrogen concentrations of up to about 10% by volume or higher can also become possible in reproducible fashion. Owing to the purely optical functioning, 100% explosion protection is afforded including in the danger area.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A hydrogen sensor comprising a radiation source, by means of which radiation is radiated onto a sensor medium, wherein the sensor medium has a transmission coefficient that varies depending on the concentration of hydrogen in the environment of the sensor medium, and with a detector which detects at least a portion of the radiation transported through the sensor medium, wherein a reflector is provided which reflects the radiation transmitted through the sensor medium back to the sensor medium.

2. The hydrogen sensor as claimed in claim 1, wherein the sensor medium is applied on a substrate.

3. The hydrogen sensor as claimed in claim 2, wherein the substrate is the reflector or a reflector is applied on the substrate.

4. The hydrogen sensor as claimed in claim 3, further including a buffer layer between the substrate and the sensor medium.

5. The hydrogen sensor as claimed in claim 1, further comprising a covering layer on the sensor medium.

6. The hydrogen sensor as claimed in claim 1, wherein the sensor medium is embodied as a layer.

7. The hydrogen sensor as claimed in claim 1, wherein the sensor medium comprises clusters of palladium, palladium alloys, yttrium, scandium, at least one lanthanide, at least one actinoide, tungsten oxide and/or vanadium oxide and/or a mixture or compound of these materials.

8. The hydrogen sensor as claimed in claim 7, wherein the clusters are embedded in a matrix composed of a different material, in particular of a polymer.

9. The hydrogen sensor as claimed in claim 7, wherein the clusters have a diameter of about 1 nm to about 30 nm.

10. The hydrogen sensor as claimed in claim 8, wherein the polymer comprises polytetrafluoroethylene, polyterephthalate, polyimide, polymethyl methacrylate and/or polycarbonate.

11. The hydrogen sensor as claimed in claim 1, further comprising at least one first optical waveguide for conducting radiation from a radiation source to the sensor medium.

12. The hydrogen sensor as claimed in claim 1, further comprising at least one second optical waveguide for conducting radiation from the sensor medium to the detector.

13. The hydrogen sensor as claimed in claim 12, wherein the at least one first optical waveguide and the at least one second optical waveguide run substantially parallel to each other at least in sections.

14. The hydrogen sensor as claimed in claim 11, further comprising a lens at that end of the at least one first second optical waveguide and/or of the at least one second optical waveguide which is directed to the sensor medium.

15. A hydrogen sensor comprising a radiation source, by means of which radiation is radiated onto a sensor medium, wherein the sensor medium has a transmission coefficient that varies depending on the concentration of hydrogen in the environment of the sensor medium, and with a detector which detects at least a portion of the radiation transported through the sensor medium, wherein the sensor medium comprises clusters containing or composed of a palladium alloy, yttrium, scandium, at least one lanthanide, at least one actinoide, tungsten oxide and/or vanadium oxide and/or a mixture or compound of these materials.

16. The hydrogen sensor as claimed in claim 15, wherein the clusters are embedded in a matrix composed of a different material, in particular of a polymer.

17. The hydrogen sensor as claimed in claim 15, wherein the clusters have a diameter (D) of about 1 nm to about 30 nm.

18. The hydrogen sensor as claimed in claim 16, wherein the polymer comprises polytetrafluoroethylene, polyterephthalate, polyimide, polymethyl methacrylate and/or polycarbonate.

19. The hydrogen sensor as claimed in claim 18, further comprising a buffer layer between the substrate and the sensor medium.

20. The hydrogen sensor as claimed in claim 15, further comprising a covering layer on the sensor medium.

21. The hydrogen sensor as claimed in claim 15, wherein the sensor medium is embodied as a layer.
